(19) United States
(12) Patent Application Publication
(10) Pub. No.: US 2016/0069734 A1
(43) Pub. Date: Mar. 10, 2016

(54) INFANT WEIGHT MEASUREMENT APPARATUS AND METHOD

(71) Applicant: General Electric Company, Schenectady, NY (US)

(72) Inventor: Belsinger Harry, Jr., Forest Hill, MD (US)

(21) Appl. No.: 14/479,927

(22) Filed: Sep. 8, 2014

(51) Int. Cl. G01G 19/44; G01G 23/37

(52) U.S. Cl. CPC G01G 19/445; G01G 23/37

(57) ABSTRACT

The present application discloses an apparatus for weighing an infant. The apparatus comprises a patient sling configured to support the infant, a first handle connected to the patient sling and including a first load sensor and a second handle connected to the patient sling and including a second load sensor. The first and second load sensors are each configured to generate a signal indicative of a portion of a force applied to the apparatus by the infant. The apparatus includes a processor configured to receive the signals from the first and second load cells and calculate an infant weight and a display operatively connected to the processor and configured to display the calculated infant weight.

### BACKGROUND OF THE INVENTION

The subject matter disclosed herein relates to an apparatus and method for weighing an infant. More specifically, the present disclosure relates to a patient transfer device that can be used to weigh and support a patient during movement while providing minimal patient stimulation.

Presently, current practice is to cut the umbilical cord and weigh an infant on a table-top or in-bed scale, which is often located across the room from the mother. However, in some clinical cases, such as when emergency respiratory support is needed, the weight of the baby may be needed more rapidly. Infant weight may be used, for example, to determine tidal volume for resuscitation or dosage for administration of medications. In this type of situation, obtaining the infant weight by current practice may be difficult and instead a clinician may estimate the infant weight. Additionally, the desire to leave the umbilical cord intact for some period of time following delivery makes obtaining an infant weight with a traditional scale difficult.

Therefore, it is desirable to have a device and method for obtaining a more accurate infant weight quickly at a location near the mother instead of transferring the infant to a table-top or in-bed scale or visually estimating the weight as is often done.

### BRIEF DESCRIPTION OF THE INVENTION

The above-mentioned shortcomings, disadvantages and problems are addressed herein which will be understood by reading and understanding the following specification.

In an embodiment, an apparatus for weighing an infant comprises a patient sling configured to support the infant, a first handle connected to the patient sling and including a first load sensor and a second handle connected to the patient sling and including a second load sensor. The first and second load sensors are each configured to generate a signal indicative of a portion of a force applied to the apparatus by the infant. The apparatus includes a processor configured to receive the signals from the first and second load cells and calculate an infant weight and a display operatively connected to the processor and configured to display the calculated infant weight.

In another embodiment, an apparatus for weighing an infant comprises a patient sling having a first and second handle. The first handle comprises a first pair of load sensors and the second handle comprises a second pair of load sensors. Each of the load sensors of the first and second pairs is configured to receive a portion of a force applied to the apparatus by the infant and to generate a signal indicative thereof. The apparatus includes a processor configured to receive the signals from each of the load sensors of the first and second pairs, calculate an infant weight, and display the infant weight on a display operatively connected to the patient sling.

In another embodiment, a method of weighing an infant patient comprises positioning the infant patient on a patient transfer device, the patient transfer device comprising a patient sling, a first handle connected to the patient sling and including a first load sensor, and a second handle connected to the patient sling and including a second load sensor. The method includes lifting the patient transfer device by the first and second handles, calculating an infant weight with a processor, and displaying the infant weight on a display connected to the patient transfer device.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram of a patient transfer device in accordance with an embodiment of the disclosure;

FIG. 2 is a top perspective view of the patient transfer device in accordance with an embodiment of the disclosure;

FIG. 3 is a schematic diagram of a patient transfer device in accordance with another embodiment of the disclosure; and

FIG. 4 is a flowchart of a method for weighing an infant in accordance with an embodiment of the disclosure.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

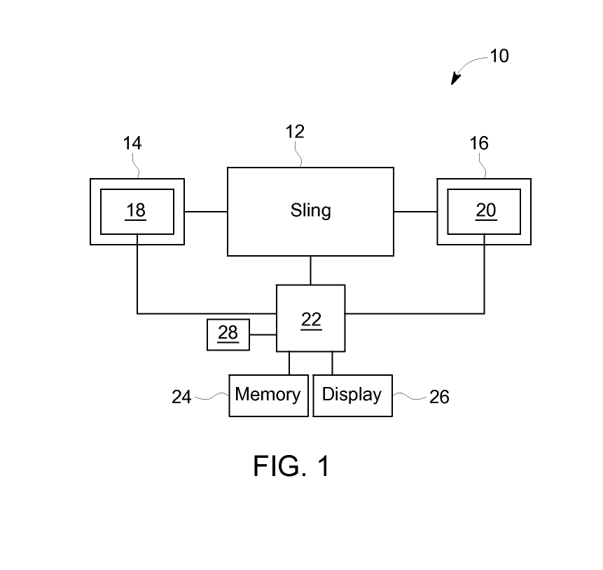

FIG. 1 is a schematic diagram of a patient transfer device 10 in accordance with the present disclosure. The patient transfer device 10 can be used to handle an infant patient, such as a newborn or neonate, weigh the infant patient, and transfer the infant patient from one location to another while minimizing physical contact between a physician or caregiver and the patient but while still providing thermal and physical support to the infant patient.

The patient transfer device 10 comprises a patient sling 12 configured to support the infant, a first handle 14 connected to the patient sling 12 and a second handle 16 connected to the patient sling 12. The first and second handles 14, 16 are configured to be grasped by a clinician in order to move or transport the patient transfer device 10 with as little as a single hand. It should be appreciated that the use of two hands to grasp the handles 14, 16 is also within the scope of the present disclosure.

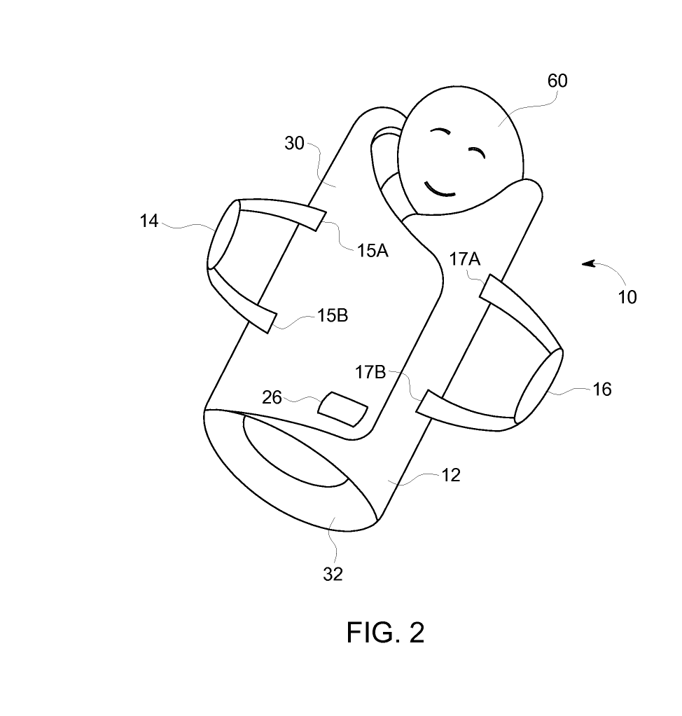

FIG. 2 is a perspective view of the patient transfer device 10 in accordance with an embodiment of the disclosure. In this embodiment, an infant 60 may be positioned on an interior side 32 of the sling 12. Sling 12 is at least partially flexible and is configured to be positioned so as to surround the infant 60. The first and second handles 14, 16 are attached to opposite ends of an exterior side 30 of the patient sling 12. The first handle 14 is attached to the sling 12 at attachment points 15 A, B. The second handle 16 is attached to the sling 12 at attachment points 17 A, B. While two attachment points 15 A, B and 17 A, B for handles 14, 16, respectively, are depicted in FIG. 2, more or fewer attachment points may be envisioned.

It should be appreciated that the manner in which the handles 14, 16 are connected to sling 12 may vary. For example, the handles 14, 16 may be fixedly attached to the sling 12, by sewing or another method. Handles 14, 16 may also be integral to the sling 12. In another embodiment, the handles 14, 16 may be releasably coupled by a fastener such as a button or a snap. In yet another example, the handles 14, 16 may be attached to the interior side 32 and extend through the sling 12 to the exterior side 30. It should also be appreciated that the positioning of the handles 14, 16, with respect to the length of the sling 12 may vary. For example as shown in FIG. 2, the handles 14, 16 may be substantially centered along the length of the sling 12. In another embodiment, the handles 14, 16 may be positioned off-center.

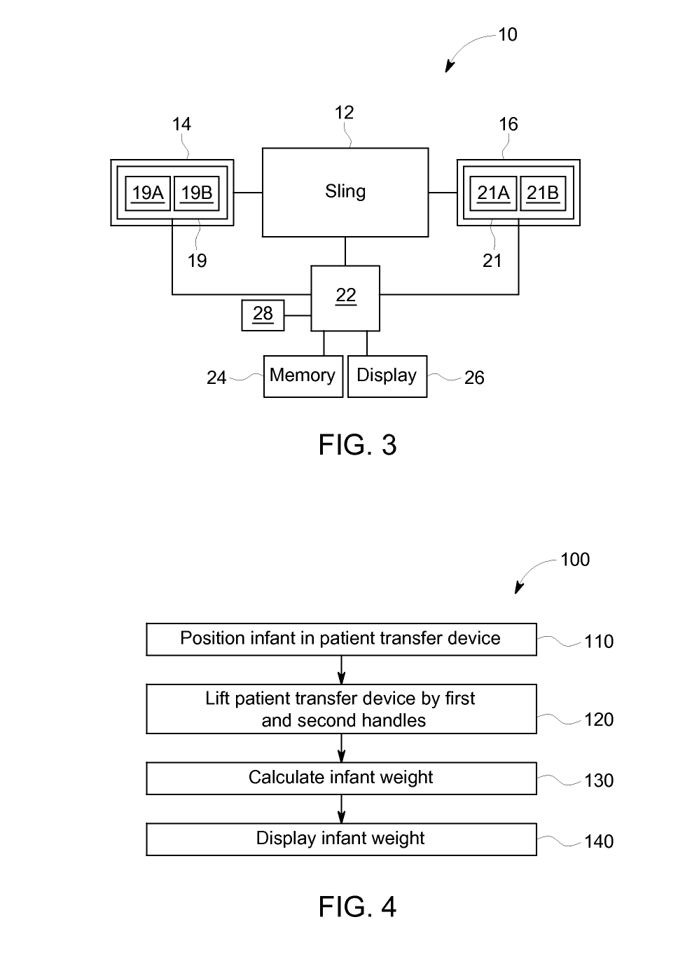

Turning back to FIG. 1, the first handle 14 includes a first load sensor 18 and the second handle 16 includes a second load sensor 20. It should be appreciated that the first and second handles 14, 16 may each include more than one load sensor. For example, as depicted in FIG. 3, the first and second handles 14, 16 each comprise a pair of load sensors 19, 21. In the embodiment depicted in FIG. 1, first and second load sensors 18, 20 are each configured to receive at least a portion of the force applied to the device 10 by the infant patient (not pictured) and generate a signal indicative thereof.

The first and second load sensors 18, 20 may be load cells. For the purpose herein, a load cell is defined as a transducer that converts a force into an electrical signal. The first and second load sensors 18, 20 could be strain gauge load cells, hydraulic load cells, pneumatic load cells, or any other type of device capable of measuring force. The first and second load sensors 18, 20 may also be a mechanical device that measures the force upon the handles, such as a spring scale.

The patient transfer device 10 may comprise a processor 22. The processor 22 is connected to the load sensors 18, 20 and is configured to receive the respective signals from the first and second load sensors 18, 20. The processor 22 is further configured to calculate the infant weight. In one embodiment, the processor 22 is configured to sum the signals from the first and second load sensors 18, 20 and subtract a known apparatus weight to calculate the infant weight. The known apparatus weight may vary depending on the positioning of the first and second load sensors 18, 20 within handles 14, 16.

The patient transfer device 10 may comprise a memory 24. Memory 24 is operatively connected to the processor 22. Memory 24 may be a non-transitory computer-readable medium and may be configured to store at least one of the signals from the first and second load sensors 18, 20 and the calculated infant weight.

The patient transfer device 10 is operatively connected to a display 26. Display 26 is configured display the calculated infant weight. The display 26 may be physically connected to the patient transfer device 10 as shown in the embodiments depicted in FIGS. 1 and 2. The display 26 may also be spaced apart from the patient transfer device 10 and be wirelessly connected by a wireless device 28 to the processor 22.

In the embodiment depicted in FIG. 1, the display 26 is on the exterior 30 of the patient transfer device 10, near the infant patient's 60 feet. It should be appreciated that the positioning of the display 26 on the patient transfer device 10 may vary. For example, the display 26 may be positioned in proximity to one of the first and second handles 14, 16, or may be positioned closer to the patient's 60 head.

The patient transfer device 10 may comprise the wireless device 28 connected to the processor 22. The wireless device 28 may be configured to transmit the calculated infant weight to a remote device (not pictured) such as a display, patient monitor, infant warmer, incubator, or an electronic medical record system. The wireless device 28 may also be configured to transmit the signals from the first and second load sensor 18, 20 to a remote device (not pictured) such as a display, patient monitor, infant warmer, incubator, or an electronic medical record system.

FIG. 3 is a schematic diagram of the patient transfer device 10 in accordance with another embodiment of the disclosure. The patient transfer device 10 embodied in FIG. 3 is similar to that of FIGS. 1 and 2, except that the patient transfer device 10 comprises a first pair of load sensors 19 and a second pair of load sensors 21. The first pair of load sensors 19 comprises load sensors 19A, 19B. The second pair of load sensors 21 comprises load sensors 21A, 21B. Load sensors 19A, 19B, 21A, and 21B are each configured to receive at least a portion of the force applied to the device 10 by the infant patient (not pictured) and generate a signal indicative thereof. In this embodiment, the processor 22 is configured to receive the signals from the first and second pairs of load sensors 19, 21. To calculate the infant weight, the signals from the first and second pairs of load sensors 19, 21 are summed and the weight of the patient transfer device 10 is subtracted.

Having described the components of the patient transfer device 10, an exemplary method 100 weighing the infant 60 will now be described in connection with FIG. 4. The method 100 may include a step 110 comprising positioning the infant 60 in the patient transfer device 10. As described with respect to FIGS. 1-3, the patient transfer device 10 may comprise a patient sling 12, a first handle 14 connected to the patient sling 12, and including first load sensor 18. The patient transfer device may also comprise second handle 16 connected to the patient sling 12, and including the second load sensor 20. The first and second load sensors 18, 20 could be strain gauge load cells, hydraulic load cells, pneumatic load cells, or any other type of device capable of measuring force. The first and second load sensors 18, 20 may also be a mechanical device that measures the force upon the handles, such as a spring scale.

The method 100 may comprise a step 120 lifting the patient transfer device 10 by the first and second handles 14, 16. First and second handles 14, 16 may be configured to be brought together around the patient transfer device 10 to promote one handed grasping by the clinician. However, it should be appreciated that the use of two hands by the clinician to lift and move the patient transfer device 10 is still within the scope of the present disclosure. First and second load sensors 18, 20 are each configured to receive at least a portion of the force applied to the device 10 by the infant patient 60 and generate a signal indicative thereof.

The method 100 may comprise a step 130 calculating the infant weight. The processor 22 may be configured to receive signals from the first and second load sensors 18, 20. The processor may be further configured to calculate the infant weight by summing the signals from each of the load sensors 18, 20 while accounting for the known weight of the patient transfer device 10. In one embodiment, the calculating step may comprise summing the signals from at least the first and second load sensors 18, 20 and subtracting the known weight of the patient transfer device 10. In another embodiment, the calculating step 130 may comprise summing the signals from the first and second pairs of load sensors 19, 21 and then subtracting the known weight of the patient transfer device. It should be appreciated that the processor 22 may be comprised within the patient transfer device, but in another embodiment, the processor 22 may be operatively connected through a wired or wireless connection to a processor remote from the patient transfer device 10.

The method may comprise a step 140 displaying the infant weight on a display connected to the patient transfer device. The display 26 may be integrally connected to the patient transfer device 10. It should be appreciated that other embodiments of the display 26 may be envisioned. For example, the display 26 may be operatively connected via a wired connection to a device such as a patient monitor, incubator or infant warmer. In another example, the display 26 may be operatively connected wirelessly to a remote device such as an infant warmer, incubator, electronic medical record system, or a combination thereof.

The method 100 allows for the quick and accurate measurement of an infant weight with minimal stimulation of the infant due to human contact. The method 100 also allows for the measurement, instead of estimation, of infant weight should delayed cord clamping be desired.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

I claim:

1. An apparatus for weighing an infant, comprising:
a patient sling configured to support the infant,
a first handle connected to the patient sling and including a first load sensor;
a second handle connected to the patient sling and including a second load sensor;
wherein the first and second load sensors are each configured to generate a signal indicative of a portion of a force applied to the apparatus by the infant;
a processor configured to receive the signals from the first and second load cells and calculate an infant weight; and
a display operatively connected to the processor and configured to display the calculated infant weight.

2. The apparatus of claim 1, wherein at least one of the first and second load sensors are strain gauge load cells.

3. The apparatus of claim 1, wherein the processor is configured to sum the signals from the first and second load sensors and subtract a known apparatus weight to calculate the infant weight.

4. The apparatus of claim 1, further comprising a wireless device configured to transmit the calculated infant weight.

5. The apparatus of claim 1, further comprising a memory operatively connected to the processor.

6. The apparatus of claim 5, wherein the memory is configured to store the signals from the load sensors.

7. The apparatus of claim 5, wherein the memory is configured to store the calculated infant weight.

8. An apparatus for weighing an infant, comprising:
a patient sling having a first and second handle;
the first handle comprising a first pair of load sensors and the second handle comprising a second pair of load sensors;
wherein each of the load sensors of the first and second pairs is configured to receive a portion of a force applied to the apparatus by the infant and to generate a signal indicative thereof; and
a processor configured to receive the signals from each of the load sensors of the first and second pairs, calculate an infant weight, and display the infant weight on a display operatively connected to the patient sling.

9. The apparatus of claim 8, further comprising a wireless device configured to transmit the infant weight to the display, wherein the display is wirelessly connected to the patient sling.

10. The apparatus of claim 8, wherein the first and second pairs of load sensors are strain gauge load cells.

11. The apparatus of claim 8, wherein the processor sums the signals from the first and second pairs of load sensors and subtracts a known apparatus weight to calculate the infant weight.

12. The apparatus of claim 8, further comprising a wireless device configured to transmit the calculated infant weight.

13. The apparatus of claim 8, further comprising a memory configured to store the signals from the load sensors.

14. The apparatus of claim 8, further comprising a memory configured to store the calculated infant weight.

15. A method of weighing an infant patient, comprising:
positioning the infant patient on a patient transfer device, the patient transfer device comprising a patient sling, a first handle connected to the patient sling and including a first load sensor, and a second handle connected to the patient sling and including a second load sensor;
lifting the patient transfer device by the first and second handles;
calculating an infant weight with a processor; and
displaying the infant weight on a display connected to the patient transfer device.

16. The method of claim 15, wherein the calculating step comprises receiving a signal from each of the first and second load sensors.

17. The method of claim 16, wherein the calculating step further comprises summing the signals from the first and second load sensors.

18. The method of claim 15, wherein the display is wirelessly connected to the patient transfer device.

19. The method of claim 15, wherein the first and second load sensors are strain gauge load cells.

20. The method of claim 15, further comprising storing on a memory at least one of the signals from the first and second load sensors and the calculated infant weight.
